(19) United States
(12) Patent Application Publication
(10) Pub. No.: US 2023/0009882 A1
(43) Pub. Date: Jan. 12, 2023

(54) PORTABLE COMPUTER

(71) Applicant: Moshe Gabbay, Bney-Brak (IL)

(72) Inventors: Moshe Gabbay, Bney-Brak (IL); Shimon Mizrahi, Jerusalem (IL)

(21) Appl. No.: 17/658,650

(22) Filed: Apr. 10, 2022

Related U.S. Application Data
(63) Continuation-in-part of application No. 17/369,986, filed on Jul. 8, 2021, now Pat. No. 11,327,530.

(51) Int. Cl. G03B 21/14; G03B 21/58; G02B 26/08; G06F 1/16

(52) U.S. Cl. CPC G03B 21/145; G03B 21/58; G02B 26/0833; G06F 1/1616

(57) ABSTRACT

A portable computer including a body having a processor is provided. The portable computer include a foldable member coupled to an edge of the body. The portable computer includes a monitor mounted on the foldable member and being configured to display data in a first direction with respect to the foldable member; an imaging device configured to receive data from the processor and to form a light beam representing the data; and an optical member configured to receive the light beam and to project an image in a second direction with respect to the foldable member.

### FIELD OF INVENTION

The presently disclosed subject matter relates to a portable computer in general and, in particular, to a portable computer having a projecting device.

### BACKGROUND

The market for portable computers provides a large variety of personal computers, handheld devices, and laptops. The extensive use of portable computers provides the ability to present data, such as images, presentations, etc., to a large audience, by coupling the portable computers to a projector. There is a long-felt need for a portable computer that provides integrated projection capabilities.

### SUMMARY OF INVENTION

There is provided in accordance with an aspect of the presently disclosed subject matter a portable computer including a body having a processor and a foldable member coupled to an edge of the body. The portable computer includes a monitor mounted on the foldable member and being configured to display data in a first direction with respect to the foldable member; an imaging device configured to receive data from the processor and to form a light beam representing the data; and an optical member configured to receive the light beam and to project an image in a second direction with respect to the foldable member.

The imaging device can include a set of digital micromirrors configured for digital light processing of the data.

The imaging device can include a MEMS scanning laser.

The optical member can include a projector head mounted on the monitor and an optical fiber configured to transmit the light beam from the imaging device to the projector head.

The projector head can be mounted on a backside of the monitor and being configured to project the image in the second direction opposite the first direction.

The imaging device can include a light emitter mounted on the body, a mirror mounted on the edge of the body and a reflector mounted on backside of the monitor;

wherein the light emitter is configured to project the light beam towards the mirror, the mirror is configured to reflect the light beam towards the reflector, and the reflector is configured to project the image in the second direction opposite the first direction.

The mirror can extend from the edge of the body below the backside of the monitor.

The mirror can be selectively movable between a deployed position in which the mirror extends away from the edge of the body and reflects the light beam towards the backside of the monitor, and a close position, in which the mirror is engages the edge of the body.

The backside of the monitor can define a two-dimensional plan and wherein the reflector is movable along the two-dimensional plan.

The mirror can be configured to detect location of the reflector and to direct the light beam towards the reflector.

The location of the reflector with respect to the two-dimensional plan can be determined in accordance with an angle of the foldable member with respect to the body.

The reflector can include an accelerometer configured for detecting the angle, and wherein location of the reflector is determined such that the image is projected in the second direction, wherein the second direction is maintained at a predetermined angle with respect to the body.

The imaging device and the optical member can be expendably mounted inside the body, and are configured to selectively extend from a side of the body.

The imaging device and the optical member can be encased in a housing mountable in a CD port and being provided with a coupling member, for coupling to a motherboard of the laptop.

The imaging device can be mounted inside the body and wherein the optical member is mounted on the foldable member

The portable computer can further include an optical fiber coupled to the imaging device and being configured to transmit the light beam to the optical member.

The optical member can include micromirror devices for receiving the light beam and for forming the image.

The optical member can further include a collimator configured to receive the light beam from the optical fiber and to transmit an aligned beam towards the micromirror devices.

The optical member can include a scanning mirror device for receiving the light beam and for forming the image.

The optical member can further include a collimator configured to receive the light beam from the optical fiber and to transmit an aligned beam towards the scanning mirror device

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1A is a side view of a portable computer having a projecting device in accordance with an example of the presently disclosed subject matter;

FIG. 1B is a side view of the portable computer of FIG. 1A, showing the projecting device in another position;

FIG. 2A is a side view of a portable computer having a projecting device in accordance with another example of the presently disclosed subject matter;

FIG. 2B is a side view of a portable computer having a projecting device in accordance with yet another example of the presently disclosed subject matter;

FIG. 3 is a side view of a portable computer having a projecting device in accordance with a further example of the presently disclosed subject matter;

FIG. 4 is a block diagram illustration of the projecting device of FIG. 3;

FIG. 5A is a side view of a portable computer having a projecting device in accordance with a further example of the presently disclosed subject matter; and

FIG. 5A is a top view of the portable computer of FIG. 5A.

### DETAILED DESCRIPTION OF EMBODIMENTS

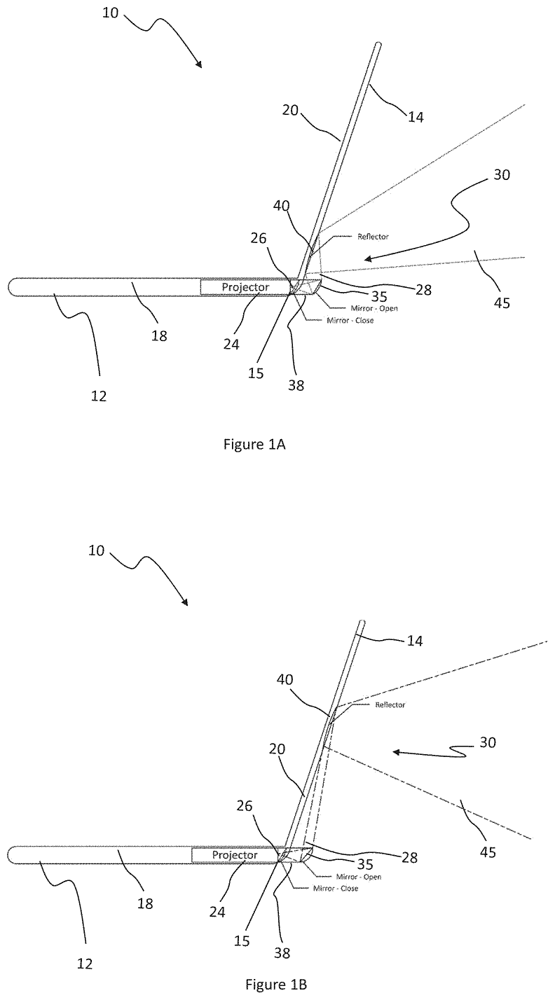

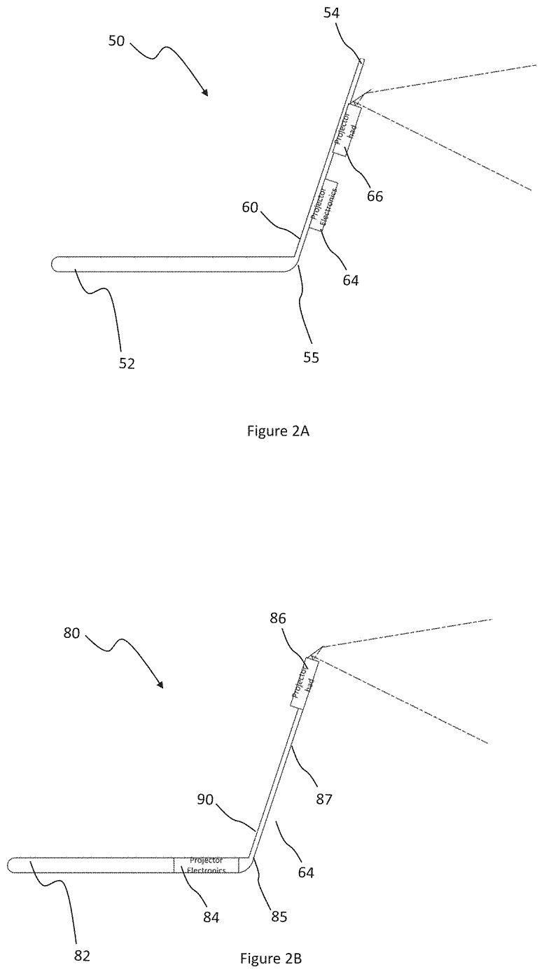

FIG. 1A shows a portable computer 10 having a projecting device and including a body 12 having a processor 18, and a foldable member 14 coupled to a back edge 15 of the body 12. The portable computer includes a monitor 20 mounted on the foldable member 14 and is configured to display data in the direction of the user of the portable computer 10. The portable computer 10 further includes an imaging device 24 configured to receive data from the processor 18 and to form a light beam 28 representing the data. In other words, the imaging device includes a set of light sources which are configured to convert digital data to a beam of light containing the data. The portable computer 10 further includes an optical member 30 configured to receive the light beam and to project an image towards a wall. The optical member 30 can be mounted on the foldable member 14 and can be configured to project the image in a direction that is opposite of the direction of the display of the monitor 20. Thus, while the user can use the portable computer 10 while viewing the data displayed on the monitor 20, the optical member 30 projects an image on the wall which can be viewed, for example, by the audience.

Alternatively, the optical member 30 can be configured to project the image on the wall at the back of the user. Thus, while the monitor displays data in the direction of the user, the image is projected in the direction of the wall, at the back of the user.

The imaging device 24 can include any known optical systems of projectors, such as Liquid-Crystal Display (LCD) Projectors, Digital Light Processing (DLP) Projectors, Liquid-Crystal on Silicon (LCoS) Projectors, or Scanning mirror Projector. The imaging device 24 is configured such that it can be embedded in the body of the portable computer 10. For example, in a case of a laptop having a horizontal body and a foldable monitor, the imaging device 24 can be embedded in the body of the laptop.

According to the illustrated example, the portable computer 10 includes a hinge on the back edge 15 of the body, about which hinge the foldable member 14 is rotated between a folded position and an open position. According to this example, the imaging device 24 includes a light emitter 26 configured to emit the beam of light 28 from the back edge 15 of the body, below the foldable member 14. According to this example, the beam of light is received by the optical member 30, which according to the present example, includes a mirror 35, and a reflector 40. The reflector 40 is mounted on the backside of the foldable member 14, and the mirror 35 is mounted at the back edge 15. The mirror 35 is disposed with respect to the light emitter 26 such that the light beam 28 is reflected towards the reflector 40. The reflector 40 is configured to project an image 45 towards a distanced wall or a screen, i.e., in a direction opposite of the direction of the monitor 20.

According to an example, the mirror 35 can be mounted in an extending holder 38, which is mounted at the back edge 15 of the portable computer 10. The extending holder 38 can be configured to selectively movable between a deployed position in which the mirror 35 extends away from the edge 15 and reflects the light beam 28 towards the reflector 40, and a close position (shown in dashed lines), in which the mirror 35 engages the edge of the body.

This way, the extending holder 38 can be deployed when projecting an image is required and can be closed when a projection is not required, thus protecting the mirror 35 and maintaining the compactness of the portable computer 10.

It is appreciated that the location of the mirror 35 along the length of the back edge 15 can be determined in accordance with the location of the imaging device 24 and the light emitter 26 inside the body 12. Similarly, the location of the reflector 40 with respect to the horizontal axis of the foldable member 14 can be determined in accordance with the location of the mirror 35.

According to another example, the reflector 40 can be movable along the backside of the foldable member 14. For example, the reflector 40 can be movable up and down on the foldable member 14 adjusting thereby the angle of the projected image 45. This way, the direction and angle of the projected image 45 can be determined as required. According to an example, the mirror 35 can be configured to detect the location of the reflector 40 and to direct the light beam 28 towards the reflector 40. For example, as shown in FIG. 1B, if the reflector 40 is displaced to the top of the foldable member 14 the angle of the mirror 35 can be automatically adjusted such that the light beam 28 is directed to the reflector 40.

It is noted that the position of the reflector 40 can be adjusted in accordance with the angle of the foldable member 14. In other words, since the reflector 40 is mounted on the foldable member 14 the angle at which the image 45 is projected varies in accordance with the angle of the foldable member 14. According to a further example, the reflector 40 can include an accelerometer 48 configured for detecting the angle of the foldable member 14. The location of the reflector 40 can be determined such that the image 45 is projected at a predetermined angle with respect to the body 12. According to this example, the reflector 40 can include a displacing mechanism for moving the reflector 40 along the height of the foldable member 14.

The body 12 of the portable computer 10 can further include adjustable feet at the bottom thereof, facilitating thereby raising the portable computer 10 and adjusting the angle at which the image is projected on the wall.

With reference to FIG. 2A, according to another example of the presently disclosed subject matter, the portable computer 50 having a projecting device can include a body 52 and a foldable member 54 coupled to a back edge 55 of the body 52 and having a monitor 60 displaying in a first direction. The imaging device and the optical member, according to this example, include a projector electronic 64 for forming the required image to be projected and a projector head 66. Thus, according to this example light beam is formed inside the projector head 66 and is projected towards the wall. The advantage of the device, according to this example, is that the light beam does not have to be transmitted from the imaging device toward the optical member. Rather the portion of the imaging device which forms the light beam is inside the projector head 66.

According to this example, the projector head 66 can include the light source for projecting the image, but also includes imaging capabilities such as Digital Light chip of Digital Light Processing for forming the image to be projected. The projector electronic 64, on the other hand, provides the signals for controlling the operation of the digital light processor.

Similarly, as shown in FIG. 2B, according to another example of the presently disclosed subject matter, the portable computer 80 can include a body 82 and a foldable member 87 coupled to a back edge 85 of the body 82 and having a monitor 90 displaying in a first direction. The imaging device and the optical member, according to this example, include a projector electronic 84 for forming the required image to be projected and a projector head 86. The projector electronic 84, according to this example, is mounted inside the body 82 of the portable computer 80, while the projector head 86 receives electronic signals from the projector electronic 84 and forms the image to be projected. Here too, the light beam is not formed in the projector electronic 84 and thus does not have to be transmitted from the imaging device towards the optical member.

It is noted that according to the examples of FIGS. 2A and 2B, the projector heads 66 and 86 include the projecting light sources and optics, as well as the imaging devices for forming the image. Thus, the projector heads must have certain dimensions which might compromise the compactness of the laptop. Thus, according to the example shown in FIG. 2B, the projector head 86 can be mounted on the front side of the foldable member, and the body of the computer can include a designated socket 90, for encasing the projector head 86 when the laptop is folded to its stowed position.

It would be appreciated by those skilled in the art that the projector head 86 can be provided with optics allowing focus adjustment of the projected image. In addition, the projector head 86 can be configured for projecting a three-dimensional image. In face the imaging device of the present invention can also be configured to provide a light beam which is configured to project a three dimensional image.

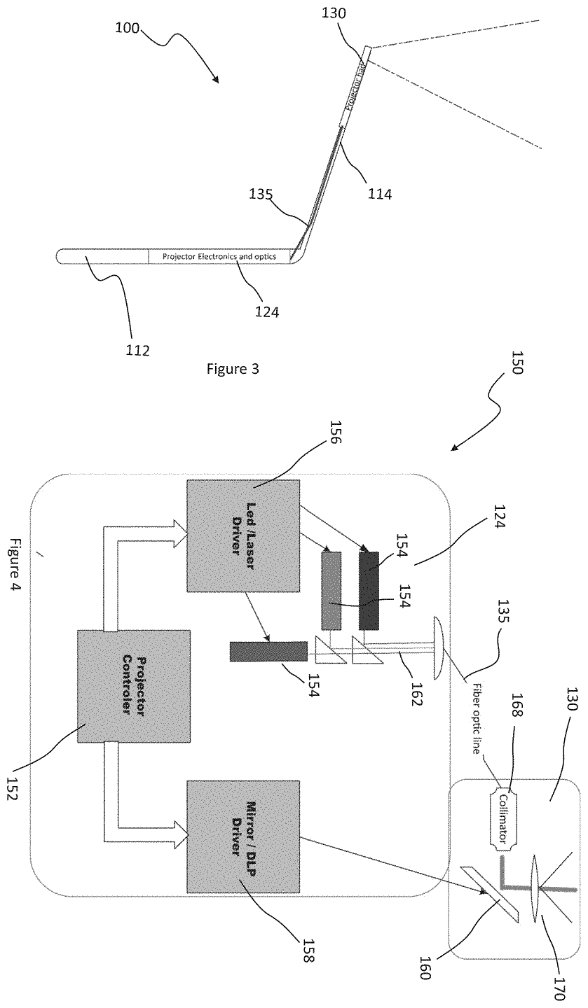

With reference to FIG. 3, according to another example, the portable computer 100 can include a body 112 and a foldable member 114. According to this example, the portable computer 100 includes an imaging device 124, which is encased inside the body 112 and is configured to receive data from the processor and to form a light beam representing the data. The portable computer 100 also includes an optical member 130 mounted on the foldable member 114 and is configured to receive the light beam from the imaging device 124 and to project an image towards a wall. The optical member 130, according to this example, includes only the optical components for projecting the image, such as lenses, etc. The light beam which is formed by the imaging device 124 is transmitted to the optical member 130 via an optical fiber 135.

According to an example, the construction of the light beam is carried out by any known optical systems for projectors, Digital Light Processing device or Scanning mirror Projectors. These technologies are known and are disclosed for example in: haps://www.maradin.co.il/products/mems-mirrors/mar1110-e-2d-scanning-mirror/ and https://www.viewsonic.com/library/entertainment/what-look-for-dlp-projector/.

As shown in FIG. 4, according to these technologies, the projection system 150 includes a projector controller 152, which forms an image by controlling a set of light sources 154, and a scanning mirror or a set of micromirrors 160. The light sources are controlled by led or laser driver 156, which uses the light sources to form a light beam 162, including certain spectrums. In addition, the projection system includes a driver 158 for controlling the operation of the scanning mirrors or the set of micromirrors 160. The light beam 162 illuminates the mirrors 160, which manipulates the light to form an image by fast displacements in two dimensions.

Thus, according to the example of FIG. 3, the imaging device 124, can include a projector controller 152, a set of light sources 154 and driver 156 to form a light beam 162. The optical member 130 on the other hand, includes the mirror devices 160 such as scanning mirrors or the set of micromirrors. The mirror devices 160 are controlled by signals sent from the driver 158, which is embedded in the imaging device 124. This way, the optical member 130, which is mounted on the foldable member 114 does not need to include the light sources 154, minimizing thereby the required space.

It is noted that the light beam 162, according to this example, must be sent from the imaging device 124 towards the optical member 130, for example, via the optical fiber 135. In order to allow the light beam 162 to enter the fiber 135 the imaging device 124 can include a coupling lens 164. In addition, in order to allow the mirror devices 160 to manipulate the light beam, the optical member 130 can include a collimator 168 which receives the light from the fiber 135 and aligns the light beam when illuminating the mirror devices 160.

The image formed by the mirror devices 160 is then projected in the direction away from the backside of the laptop by using the required optics, such as a lens 170.

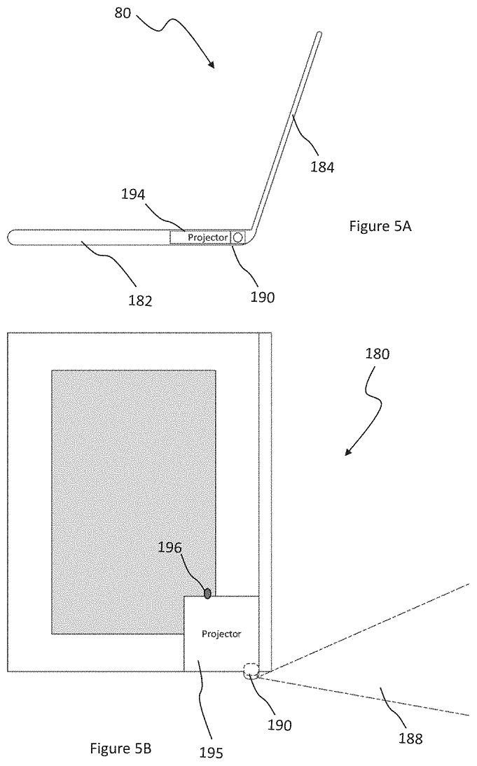

Turning now to FIGS. 5A and 5B, according to yet another example of the present invention, the portable computer 180 can include a body 182 and a foldable member 184. According to this example, the portable computer 180 includes an imaging device 194 which is encased inside the body 182 and is configured to receive data from the processor and to form a light beam 188 representing the data. The portable computer 180 also includes an optical member 190 mounted inside the body 182. The optical member 190 can be configured to selectively extend from a side of the body, such that an image can be projected towards a wall or a distanced screen.

According to an example, the imaging device 194 and the optical member 190 can be combined into a single projector case 195, which is insertable in a standard laptop CD port. This way, the projector case 195 can be mounted to a CD port of any laptop. The projector case 195 can further include a coupling member 196, for coupling to the imaging device 194 to a motherboard of the laptop.

According to a further example, the portable computer can include a folding member configured for a 360-degree rotation with respect to the body. Such the portable computer is for example used together with a touchscreen monitor, which allows folding the body of the portable computer on the back side of the monitor. According to this example, the imaging device and the optical member can be embedded in the body of the portable computer, for example on the keyboard. This way, the portable computer can be folded such that the touchscreen monitor faces the user, while the keyboard and the optical member faces the opposite direction. Alternatively, the imaging device and the optical member can be embedded at the bottom of the body. This way, the portable computer can be folded such that the touchscreen monitor faces the user, while the bottom of the body and the optical member faces the opposite direction. This way, the optical member projects an image towards a distance screen while the user views the monitor.

Those skilled in the art to which the presently disclosed subject matter pertains will readily appreciate that numerous changes, variations, and modifications can be made without departing from the scope of the invention, mutatis mutandis.

1. A portable computer including a body having a processor, and a foldable member coupled to an edge of the body, the portable computer comprising:
a monitor mounted on said foldable member and being configured to display data in a first direction with respect to said foldable member;
an imaging device configured to receive data from the processor and to form a light beam representing said data; and,
an optical member configured to receive said light beam and to project an image in a second direction with respect to said foldable member.

2. The portable computer of claim 1 wherein said imaging device includes a set of digital micromirrors configured for digital light processing of said data.

3. The portable computer of claim 1 wherein said imaging device includes a MEMS scanning laser.

4. The portable computer of claim 1 wherein said optical member includes a projector head mounted on said monitor, and an optical fiber configured to transmit said light beam from said imaging device to said projector head.

5. The portable computer of claim 4 wherein said projector head is mounted on a backside of said monitor and being configured to project said image in said second direction opposite said first direction.

6. The portable computer of claim 1 wherein said imaging device includes a light emitter mounted on the body, a mirror mounted on the edge of the body and a reflector mounted on backside of said monitor;
wherein said light emitter is configured to project said light beam towards said mirror, said mirror is configured to reflect said light beam towards said reflector, and said reflector is configured to project said image in said second direction opposite said first direction.

7. The portable computer of claim 6 wherein said mirror extends from the edge of said body below said backside of said monitor.

8. The portable computer of claim 7 wherein said mirror is selectively movable between a deployed position in which said mirror extends away from the edge of the body and reflects said light beam towards said backside of the monitor, and a close position, in which said mirror is engages the edge of the body.

9. The portable computer of claim 6 wherein said backside of the monitor defines a two-dimensional plan and wherein said reflector is movable along said two-dimensional plan.

10. The portable computer of claim 9 wherein mirror is configured to detect location of said reflector and to direct said light beam towards said reflector.

11. The portable computer of claim 9 wherein location of said reflector with respect to said two-dimensional plan is determined in accordance with an angle of said foldable member with respect to the body.

12. The portable computer of claim 11 wherein said reflector includes an accelerometer configured for detecting said angle, and wherein location of said reflector is determined such that said image is projected in said second direction, wherein said second direction is maintained at a predetermined angle with respect to said body.

13. The portable computer of claim 1 wherein said imaging device and said optical member are expendably mounted inside the body, and are configured to selectively extend from a side of said body.

14. The portable computer of claim 1 wherein said imaging device and said optical member are encased in a housing mountable in a CD port and being provided with a coupling member, for coupling to a motherboard of the laptop.

15. The portable computer of claim 1 wherein said imaging device is mounted inside the body and wherein said optical member is mounted on said foldable member

16. The portable computer of claim 15 further comprising an optical fiber coupled to said imaging device and being configured to transmit said light beam to said optical member.

17. The portable computer of claim 16 wherein said optical member includes micromirror devices for receiving said light beam and for forming said image.

18. The portable computer of claim 17 wherein said optical member further includes a collimator configured to receive said light beam from said optical fiber and to transmit an aligned beam towards said micromirror devices.

19. The portable computer of claim 16 wherein said optical member includes a scanning mirror device for receiving said light beam and for forming said image.

20. The portable computer of claim 19 wherein said optical member further includes a collimator configured to receive said light beam from said optical fiber and to transmit an aligned beam towards said scanning mirror device.
